(19) United States
(12) Patent Application Publication
(10) Pub. No.: US 2025/0356082 A1
(43) Pub. Date: Nov. 20, 2025

(54) HYBRID PHYSICS-INFORMED MACHINE LEARNING SYSTEM FOR PREDICTIVE MAINTENANCE AND THERMAL MANAGEMENT OF SUBMARINE CABLES

(71) Applicant: NEC Laboratories America, Inc., Princeton, NJ (US)

(72) Inventors: Yangmin DING, East Brunswick, NJ (US); Yue TIAN, Princeton, NJ (US); Ting WANG, West Windsor, NJ (US); Rojyar BARHEMAT, North Bergen, NJ (US)

(73) Assignee: NEC Laboratories America, Inc., Princeton, NJ (US)

(21) Appl. No.: 19/211,022

(22) Filed: May 16, 2025

Related U.S. Application Data
(60) Provisional application No. 63/648,202, filed on May 16, 2024.

(51) Int. Cl. G06F 30/23; G06F 30/18; G06F 119/08

(52) U.S. Cl. CPC G06F 30/23; G06F 30/18; G06F 2119/08

(57) ABSTRACT

Disclosed are DFOS/DTS systems, methods, and structures that employ physics-informed machine learning, Finite Element Analysis (FEA) in combination with DFOS/DTS to enhance the detection, prediction, and management of thermal anomalies in submarine cables. Our integrated approach advantageously leverages FEA to simulate accurate temperature distributions within the cable, identifies potential hot spots, and validates these with real-time DTS data. By integrating advanced machine learning algorithms, our systems and methods continuously learn from both simulated and real-world data, predicting potential failure points and suggesting preemptive maintenance actions. A hybrid model, combining data-driven and physics-based approaches, incorporates uncertainty quantification methods, providing confidence intervals for predictions. Our systems and methods enhance the reliability, efficiency, and lifespan of submarine cables, by providing anomaly detection and predictive maintenance indications for the submarine cables.

### CROSS REFERENCE TO RELATED APPLICATIONS

This application claims the benefit of U.S. Provisional Patent Application Ser. No. 63/648,202 filed May 16, 2024, the entire contents of which is incorporated by reference as if set forth at length herein.

### FIELD OF THE INVENTION

This application relates generally to distributed fiber optic sensing (DFOS) systems, methods, and structures. More particularly, it pertains to improved DFOS/Distributed Temperature Sensing (DTS) systems and methods that are combined with hybrid, physics-informed machine learning for predictive maintenance and thermal management of submarine cables.

### BACKGROUND OF THE INVENTION

As those skilled in the art will understand and appreciate, submarine (undersea) cables are vital components for transmitting electricity and data across long distances underwater. These cables are subject to various operational and environmental stresses, making them prone to thermal anomalies or localized hot spots. The formation of these thermal anomalies or hot spots can significantly impact the performance, reliability, and lifespan of the cables. If left undetected, these thermal anomalies or hot spots can lead to overheating, insulation degradation, and ultimately, cable failure. Such failures result in costly repairs, extended downtime, and disruptions to essential services.

### SUMMARY OF THE INVENTION

An advance in the art is made according to aspects of the present disclosure directed to integrated DFOS/DTS systems, methods, and structures that advantageously- and in sharp contrast to the prior art employ physics-informed machine learning, Finite Element Analysis (FEA) in combination with DFOS/DTS to enhance the detection, prediction, and management of thermal anomalies in submarine cables.

As those skilled in the art will understand and appreciate our inventive Hybrid Physics-Informed Machine Learning System for Predictive Maintenance and Thermal Management of Submarine Cables introduces a novel system for the predictive maintenance and thermal management of submarine cables, combining physics-informed machine learning, Finite Element Analysis (FEA), and Distributed Temperature Sensing (DTS).

As we shall show and describe, our integrated approach advantageously leverages FEA to simulate accurate temperature distributions within the cable, identifies potential hot spots, and validates these with real-time DTS data.

By implementing advanced machine learning algorithms, the system continuously learns from both simulated and real-world data, predicting potential failure points and suggesting preemptive maintenance actions. The hybrid model, combining data-driven and physics-based approaches, incorporates uncertainty quantification methods, providing confidence intervals for predictions.

Consequently, our comprehensive solution enhances the reliability, efficiency, and lifespan of submarine cables, addressing the limitations of current methods and advancing the state of the art in thermal anomaly detection and predictive maintenance for submarine cables.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic flow diagram showing operational details of our illustrative hybrid physics-informed machine learning system for submarine cables according to aspects of the present disclosure.

FIG. 3 shows a schematic, cross-sectional view of an illustrative submarine cable according to aspects of the present disclosure.

FIG. 4 shows material property assignments for each layer of a representative submarine cable according to aspects of the present disclosure.

FIG. 5 is a schematic diagram illustrating creation of finite mesh for cable model according to aspects of the present disclosure.

FIG. 6 is a plot of Temperature v Mesh Size illustrating mesh sensitivity for steady state heat transfer example according to aspects of the present invention.

FIG. 7 is a plot of Temperature v Radius illustrating temperature distribution in a high voltage cable according to aspects of the present disclosure.

FIG. 8 shows several illustrative features of systems and methods according to aspects of the present disclosure.

FIG. 9 is a schematic diagram showing an illustrative overview of a DFOS/DTS solution to an offshore wind turbine monitoring application according to aspects of the present disclosure.

FIG. 10 is a schematic block diagram of an illustrative computer system in which aspects of the present disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

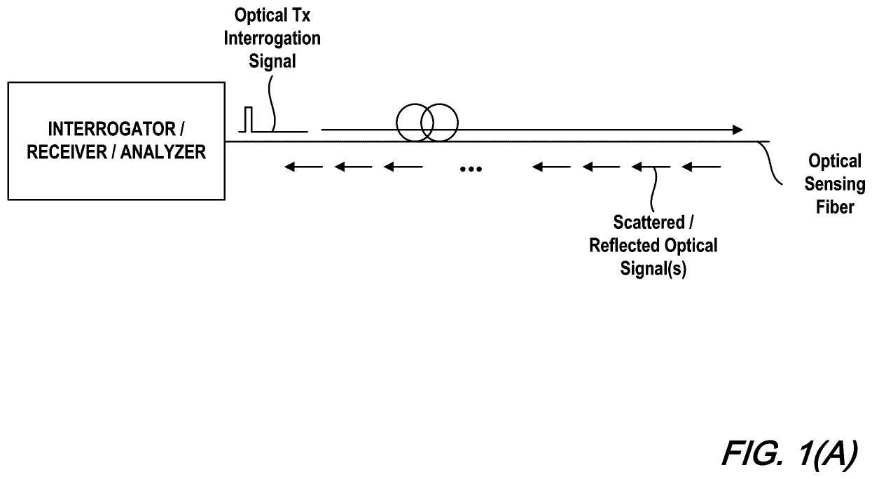

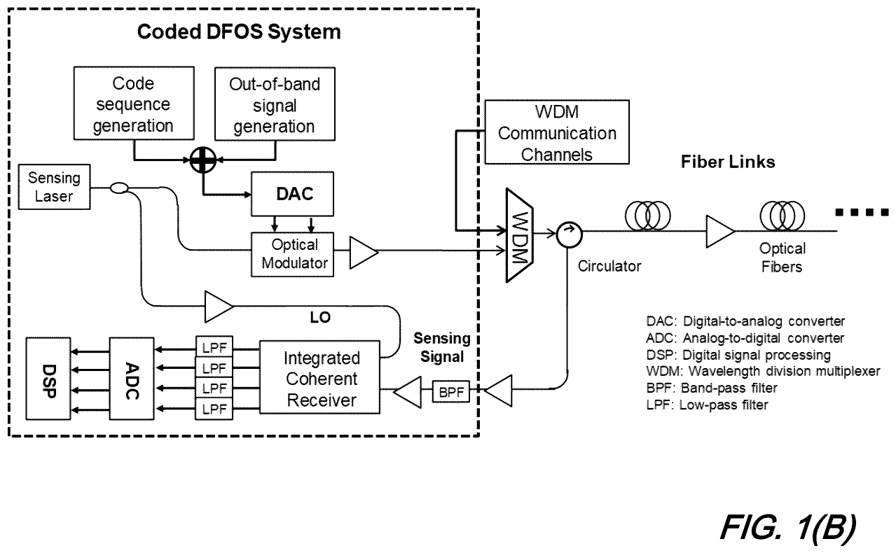

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyze reflected/backscattered and subsequently received signal(s). The signals received are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration or an indication of temperature.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered, and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

Distributed Temperature Sensing (DTS) is a technology that utilizes optical fibers as linear sensors to measure temperature continuously along their length. Instead of using discrete temperature sensors at specific points, a DTS system provides a temperature profile over the entire fiber, which can extend for many kilometers.

DTS technology primarily relies on the interaction of light with the glass structure of the optical fiber, specifically a phenomenon called Raman scattering. When a short pulse of laser light is sent into the fiber, a small portion of the light is scattered back in different wavelengths. This backscattered light contains information about the temperature at the point of scattering.

As previously noted, there are three main types of scattering, but DTS systems mainly analyze Raman scattering:
Rayleigh Scattering: Light scattered back at the same wavelength as the incident light. This is used in Optical Time Domain Reflectometry (OTDR) for locating faults in fibers but not primarily for temperature sensing in DTS.
Brillouin Scattering: Light scattered back with a slight frequency shift that is sensitive to both temperature and strain. Some DTS systems use Brillouin scattering, but careful design is needed to differentiate between temperature and strain effects.
Raman Scattering: Light scattered back at different wavelengths (Stokes and anti-Stokes lines). The intensity ratio between the anti-Stokes and Stokes lines is directly dependent on the temperature at the scattering point. The anti-Stokes line is more temperature sensitive.

Operationally, temperature and location are determined as follows.

Laser Pulse: A DTS system sends short pulses of laser light into one end of an optical sensor fiber.

Backscattering: As the light pulse travels along the fiber, Raman scattering occurs continuously at every point. This generates backscattered light with Stokes and anti-Stokes components.

Detection and Analysis: The DTS instrument at the same end of the fiber detects the returning backscattered light.

Temperature Calculation: The instrument measures the intensity of the Stokes and anti-Stokes lines. The ratio of these intensities is used to calculate the temperature at the point where the scattering occurred.

Location Determination: The location of the temperature measurement along the fiber is determined by measuring the time it takes for the backscattered light to return. This is similar to how radar works; the longer the return time, the farther the scattering point is from the instrument. This technique is known as Optical Time Domain Reflectometry (OTDR).

As we have noted, key features and advantages of DFOS and DTS in particular include at least the following.

Continuous Monitoring: Provides a temperature profile along the entire length of the fiber, offering much more information than discrete sensors.

Long Distances: Can monitor temperatures over distances of many kilometers (up to 100 km or more with some systems).

High Spatial Resolution: Can achieve temperature measurements with a spatial resolution down to one meter or even better in some specialized systems.

Immunity to Electromagnetic Interference (EMI): Optical fibers are immune to EMI, making DTS suitable for industrial environments with electrical noise.

Safety in Hazardous Environments: Low laser power levels used in many DTS systems make them safe for use in potentially explosive atmospheres.

Cost-Effective for Large Areas/Distances: Reduces the need for numerous individual sensors and their associated wiring and installation costs.

Versatile Applications: Used in a wide range of industries for various monitoring tasks.

Accordingly, and as will be readily understood and appreciated by those skilled in the art, distributed temperature sensing is a powerful technology that leverages the properties of optical fibers and light scattering to provide continuous and spatially resolved temperature measurements over long distances, offering significant advantages for a wide array of monitoring applications.

As previously noted, there exist significant challenges with respect to monitoring and maintaining submarine cables.

Challenges of existing methods include, but are not limited to the following.

Detection of Hot Spots: Traditional methods for detecting hot spots rely on either empirical data or theoretical models. Empirical methods often lack the precision required for early detection, while purely theoretical models may not accurately reflect real-world conditions.

Predictive Maintenance: Effective maintenance of submarine cables requires accurate prediction of potential failure points. Current methods do not adequately predict where and when maintenance is needed, leading to either excessive maintenance costs or unexpected failures.

Data Limitations: Distributed Temperature Sensing (DTS) provides valuable real-time temperature data along the length of the cable. However, interpreting this data accurately to predict hot spots and guide maintenance actions is challenging. DTS data alone may not capture the complex thermal interactions within the cable's structure.

Complex Thermal Interactions: Submarine cables have multiple layers, each with different thermal properties. The heat generated within a conductor due to electrical current must be accurately modeled and understood. This involves understanding complex thermal interactions between the conductor, insulation, armor, and surrounding environment.

Real-Time Adaptability: Existing systems often lack the ability to adapt to changing conditions in real-time. As a result, they cannot provide timely and accurate predictions necessary for proactive maintenance and operational adjustments.

Systems and methods according to the present disclosure address these and other challenges by providing an integrated system that combines physics-informed machine learning, Finite Element Analysis (FEA), and Distributed Temperature Sensing (DTS). These systems and methods enhance the detection, prediction, and management of thermal anomalies in submarine cables.

Particularly inventive features of our hybrid physics-informed machine learning system and methods for predictive maintenance and thermal management of submarine cables that contribute to solving the problem include the following.

### Integrated FEA Simulations

Accurate Temperature Predictions: Utilize Finite Element Analysis (FEA) to simulate temperature distributions and identify potential hot spots in submarine cables under various environmental conditions and operational loads.

Baseline Data Generation: Provide high-fidelity baseline temperature data to train the machine learning models, ensuring a robust starting point for predictive analytics.

### Machine Learning Algorithms

Predictive Maintenance: Implement machine learning algorithms that continuously learn from both simulated (FEA) and real-world temperature data to predict potential failure points and degradation in submarine cables.

Adaptive Learning: Use adaptive learning techniques to update models in real-time, incorporating new data to refine predictions and maintenance schedules.

### Distributed Temperature Sensing (DTS)

Real-time Monitoring: Integrate DTS technology to gather real-time temperature data along the length of the submarine cable, providing continuous monitoring and immediate feedback.

Data Fusion: Combine DTS data with FEA-generated data to enhance the accuracy of temperature predictions and identify anomalies or unexpected thermal events.

### Hybrid Modeling Approach

Enhanced Accuracy: Leverage the strengths of both physics-based (FEA) and data-driven (machine learning) models to achieve higher accuracy in temperature prediction and fault detection.

Refinement Mechanism: Use real-time DTS data to refine and validate the FEA model predictions, ensuring that the system adapts to actual operating conditions and environmental changes.

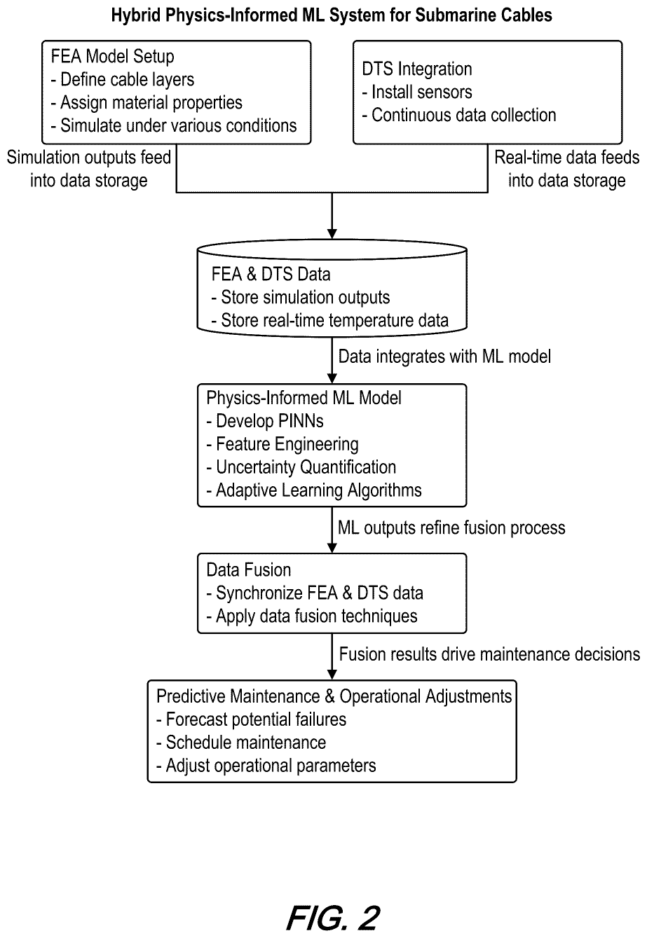

FIG. 2 is a schematic flow diagram showing operational details of our illustrative hybrid physics-informed machine learning system for submarine cables according to aspects of the present disclosure.

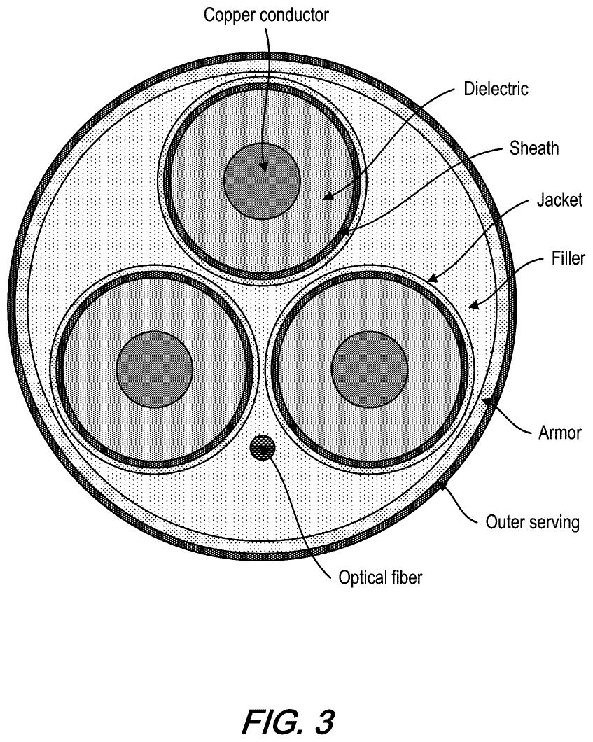

FIG. 3 shows a schematic, cross-sectional view of an illustrative submarine cable according to aspects of the present disclosure.

### Step 1: Comprehensive Finite Element Analysis (FEA) Simulation Process for Submarine Cable

### Geometry Creation

Description: In this step, we define the precise geometry of the submarine cable based on the layers mentioned: copper conductor, dielectric insulation, sheath, jacket, filler, armor, outer serving, and optical fiber. We use detailed CAD drawings or specifications from cable manufacturers to create an accurate 3D model of the cable's cross-section and length.

Copper Conductor: Typically, the central part of the submarine cable where the electric current flows. Copper is used for its excellent electrical conductivity.

Dielectric Insulation: Surrounds the conductor, usually made from cross-linked polyethylene (XLPE) or ethylene propylene rubber (EPR), providing high electric insulation while having specific thermal properties.

Sheath: A layer of lead or aluminum which acts as a moisture barrier and provides mechanical protection.

Jacket: An outer protective layer made from materials like polyethylene or PVC, designed to resist environmental damage such as abrasion and chemical corrosion.

Filler: Materials used to ensure the cable maintains a circular cross-section, providing added structural integrity and reducing spaces within the cable which might accumulate moisture or allow the inner components to move.

Armor: Layers of steel or aluminum wires or tapes, usually spirally wound around the cable to protect against physical damage from external forces like fishing equipment or anchors.

Outer Serving: Typically made of a tough polymeric material, this layer protects the armor and ensures overall integrity and resistance to environmental exposure.

Optical Fiber: In hybrid power and data cables, optical fibers are included for data transmission, requiring careful consideration due to their delicate nature and susceptibility to heat and pressure.

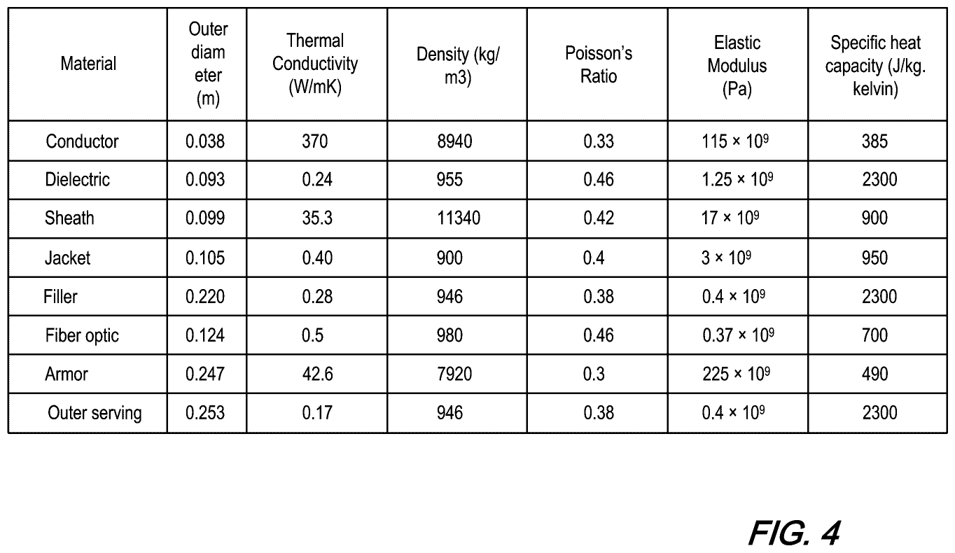

FIG. 4 shows material property assignments for each layer of a representative submarine cable according to aspects of the present disclosure.

### Material Properties Assignment

In this step, we assign appropriate material properties to each layer. Based on type of analysis, we could input physical and thermal properties such as density, elastic modulus, thermal conductivity, and specific heat capacity for materials.

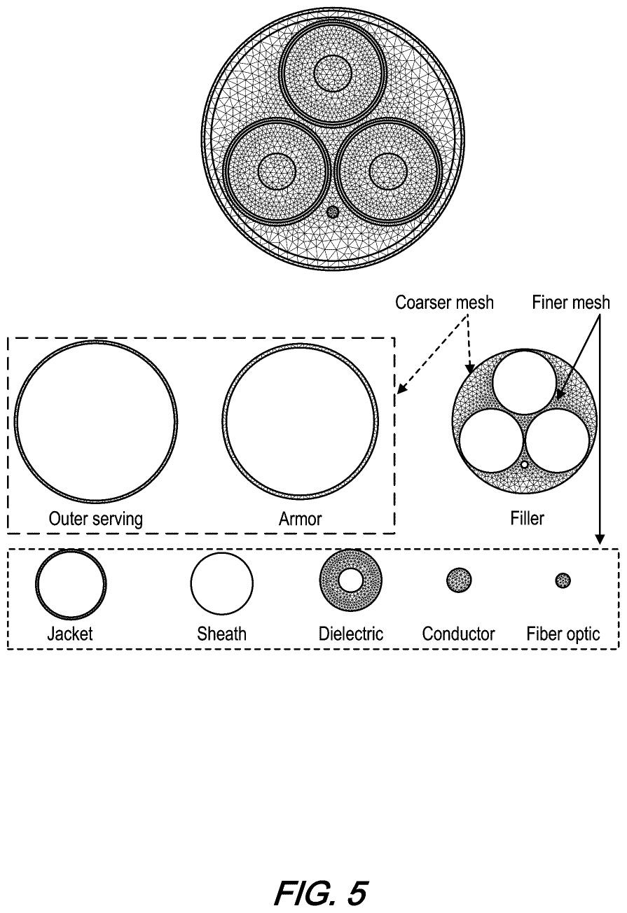

FIG. 5 is a schematic diagram illustrating creation of finite mesh for cable model according to aspects of the present disclosure.

### Mesh Generation

In this step, we create a finite element mesh for the cable model. Generate a mesh that adequately captures the complexities of each layer while balancing computational efficiency. Use finer meshes in areas with high gradient predictions like temperature or stress. For example, in the following example, we apply a finer mesh to areas of the high-voltage cable model that are subject to intense electrical and thermal stresses. Specifically, finer meshing is crucial around the conductors for precise electric field gradient modeling; at material interfaces (conductor, dielectric, and sheath) where stress peaks and potential electrical breakdowns could occur; and near conductors within the filler, which is prone to hotspots. To achieve this, we employed a finer mesh near edges and boundaries while implementing a coarser mesh in less critical regions, such as the outer serving and armor, which are distanced from the conductors and thus experience lower stress levels.

### Boundary and Initial Condition Setup

In this step, we define boundary and initial conditions for simulations. We set thermal and electrical boundary conditions based on operational scenarios (e.g., current load, ambient temperature). Include mechanical conditions if the model also assesses structural integrity (e.g., external pressure from water depth).

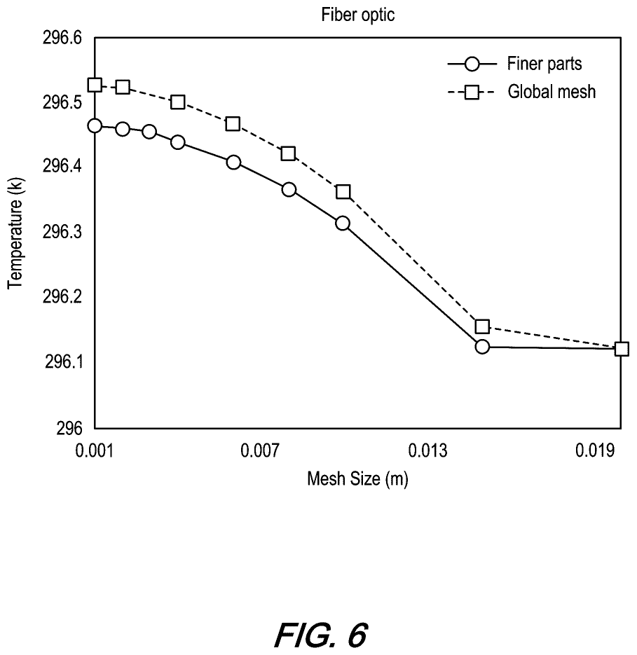

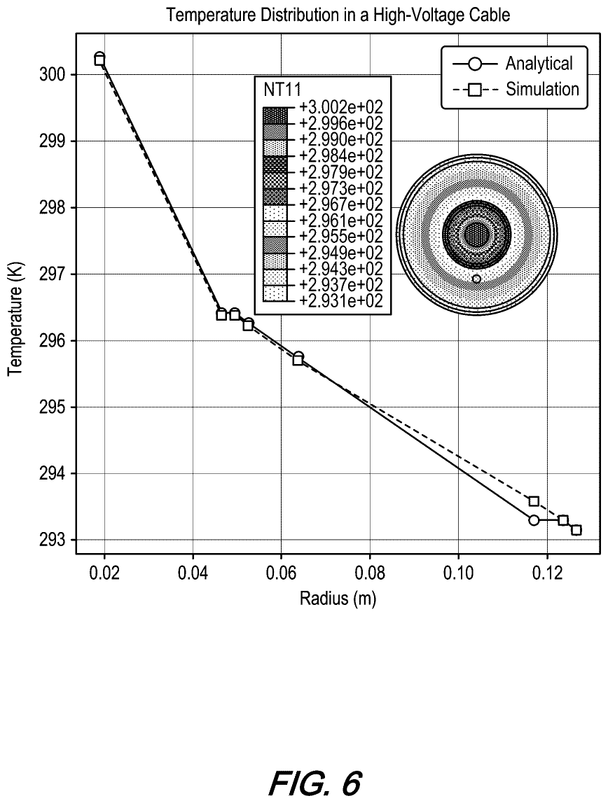

FIG. 6 is a plot of Temperature v Mesh Size illustrating mesh sensitivity for steady state heat transfer example according to aspects of the present invention.

### Mesh Sensitivity Analysis

We conduct mesh sensitivity tests to systematically refine the mesh in critical areas and compare the outcomes. Ensure that changes in the mesh do not significantly affect the simulation results, indicating that the mesh is sufficiently fine. The following figure presents an example of mesh sensitivity analysis for a steady state heat transfer example. As indicated in the figure, the mesh sensitivity analysis for the fiber optic sensor's temperature, convergence was achieved at a mesh size of 0.004 m

FIG. 7 is a plot of Temperature v Radius illustrating temperature distribution in a high voltage cable according to aspects of the present disclosure.

### Model Validation

We validate the FEA model against experimental data and known analytical solutions. We can compare outputs with simplified models or known solutions to ensure the model behaves as theoretically expected. Adjust model parameters until the simulated results align with real-world data gathered from field tests. For example, in FIG. 7, we compare the simulation result of a steady state analysis against the analytical results. The model was validated. If field or experimental data from DTS is available, we could also validate the model with those data. In this step, we run simulations under varied load and environmental conditions to predict how these factors affect cable temperature.

### Step 2: Enhanced Real-Time Data Acquisition Using Distributed Temperature Sensing (DTS)

In this step, we aim to implement high-resolution, real-time temperature monitoring of the submarine cable to identify deviations from predicted values and potential anomalies. The detailed procedure includes the following.

### Advanced DTS Configuration

Equip the submarine cable with high-density fiber optic sensors that provide temperature data with spatial resolution down to a few centimeters, ensuring comprehensive coverage.

Utilize dual-ended DTS configurations to compensate for potential signal attenuation along the length of the cable.

### Real-Time Data Processing:

Implement advanced filtering techniques such as Kalman filters to improve signal accuracy by removing random noise and other environmental interferences.

Deploy anomaly detection algorithms directly on the DTS data stream, using techniques like Sequential Probability Ratio Tests (SPRT) or Cumulative Sum (CUSUM) methods to identify significant temperature changes indicative of developing faults.

### Synchronization and Calibration:

Synchronize temperature readings from DTS with the simulation time steps of FEA outputs, adjusting for any time lags or discrepancies.

Calibrate the DTS readings against control points established through laboratory tests to ensure measurement accuracy.

### Step 3: Integrative Data Analysis and Model Refinement

In this step, we combine FEA and DTS data to refine simulations and enhance model accuracy based on real-world feedback. The detailed procedure includes the following.

### Hybrid Data Assimilation:

Employ a data assimilation approach using ensemble methods to merge real-time DTS data with FEA results, effectively updating the simulation models with observed data to improve their predictive accuracy.

Use Ensemble Kalman Filters (EnKF) for a Bayesian update of the model parameters, incorporating observational uncertainties systematically.

### Iterative Model Updating:

Automate the iterative refinement of FEA models based on deviations found during the data assimilation process, modifying physical parameters like thermal conductivity or heat capacity to better match observed data.

Implement a version control system for model iterations that allows rollback to previous versions if new configurations yield less accurate predictions.

### Step 4: Advanced Machine Learning Algorithms for Predictive Modeling

In this step, we aim to develop and train advanced machine learning models that accurately predict thermal anomalies and potential failure points. The detailed procedure includes the following.

### Enhanced Machine Learning Models:

Design and train hybrid models that combine traditional machine learning algorithms with Deep Learning approaches, such as Convolutional Neural Networks (CNNs) for spatial pattern recognition and Recurrent Neural Networks (RNNs) for temporal data analysis.

Integrate feature engineering techniques that extract meaningful attributes from both FEA and DTS datasets, focusing on features that correlate highly with anomaly occurrences.

### Physics-Informed Machine Learning:

Develop custom loss functions in training that include terms penalizing the violation of physical laws, such as the laws of thermodynamics and heat transfer.

Utilize transfer learning to adapt pre-trained networks to the specific context of submarine cables, enhancing learning efficiency and prediction accuracy with limited labeled data.

### Step 5: Proactive Predictive Maintenance and Operational Adjustment

In this step, we utilize machine learning predictions to implement proactive maintenance strategies and operational adjustments. The detailed procedure includes the following.

### Maintenance Optimization:

Use predictive insights to plan and schedule maintenance activities during low-risk operational periods, integrating logistics optimization algorithms to reduce downtime and maintenance costs.

Develop a predictive maintenance dashboard that visualizes both the prediction results and their confidence intervals, aiding maintenance teams in decision-making.

### Dynamic System Adjustments:

We develop automated control systems that adjust operational parameters in real-time based on predictive outputs, such as dynamically adjusting electrical load or activating auxiliary cooling systems to mitigate detected risks. Then we integrate feedback mechanisms that allow the operational system to learn from each intervention, continually improving its response to predicted anomalies.

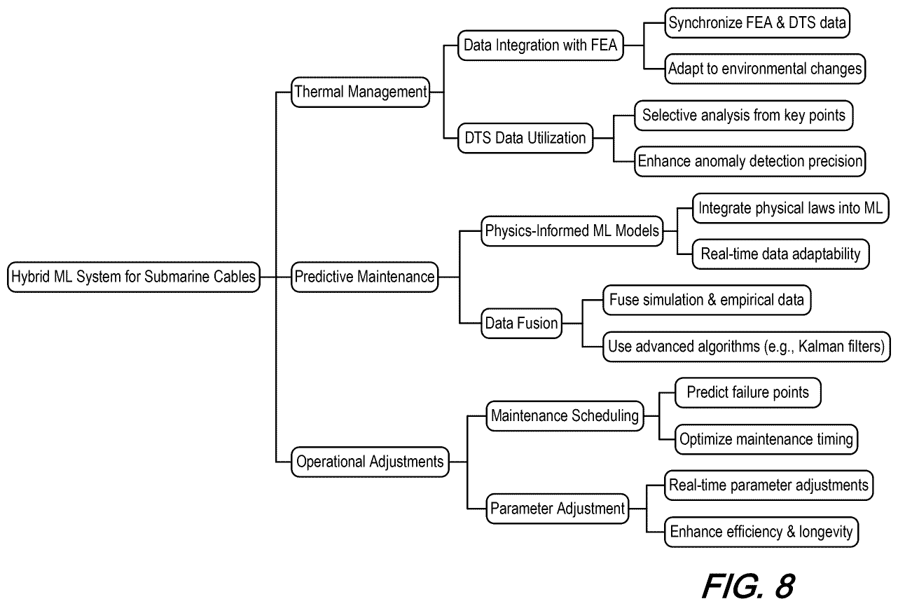

FIG. 8 shows several illustrative features of systems and methods according to aspects of the present disclosure.

### Illustrative Example—Enhancing Offshore Wind Farm Reliability

Offshore wind farms play an important role in meeting renewable energy targets, but their effective operations and maintenance (O&M) are vital for ensuring reliability and maximizing energy output. O&M activities not only impact the performance and longevity of wind turbines but also affect the overall economic viability of offshore wind projects. According to a study conducted by National Renewable Energy Laboratory (NREL), the O&M accounts for approximately one-third of the overall life cycle expenses of wind power plants. The annual costs range from $40 to $60 per kW per year for offshore wind energy. As a result, there exists considerable potential for cost reduction through the implementation of advanced O&M strategies and methodologies.

Offshore wind farms face a variety of failure modes that can significantly impact their reliability and efficiency. Some common failures include cable hotspots, foundation and tower cracks, gearbox failures, electrical component failures, and environmental impact damages. In the offshore wind industry, approximately 85% of insurance claims are due to these cable failures. Insurers face considerable losses, with the average settlement amounting to $11 million. Traditional monitoring solutions, while effective to some extent, have several limitations that can hinder the proactive management of wind farm infrastructure. Some of the methods that were introduced include vibration monitoring-based methods, strain monitoring, ultrasonic waves, acoustic emissions, impedance techniques, thermography (using infrared cameras), and laser ultrasound and etc., Each of these methods requires specific sensors, and their implementation can be complex and resource intensive.

While these traditional methods provide valuable data, they often involve complex installation processes, high maintenance costs, and limited monitoring coverage. This is where Distributed Fiber Optic Sensing (DFOS) comes into play, which as we have disclosed offers a transformative approach to monitoring and maintaining offshore wind farms.

For offshore wind submarine cables, many export and array cables have an existing fiber-optic cable integrated within the structure already. This enables the DFOS technology transforming offshore array and export cables into a comprehensive and distributed underwater sensor network. This technology provides real-time, high-resolution monitoring of temperature, strain, acoustics, and vibration in underwater and structural components, facilitating early fault detection and reducing the risk of catastrophic failures, and it minimizes the need for manual inspections, reducing human exposure. Its ability to simultaneously communicate and sense over long distances ensures swift responses to safety issues in large-scale offshore operations.

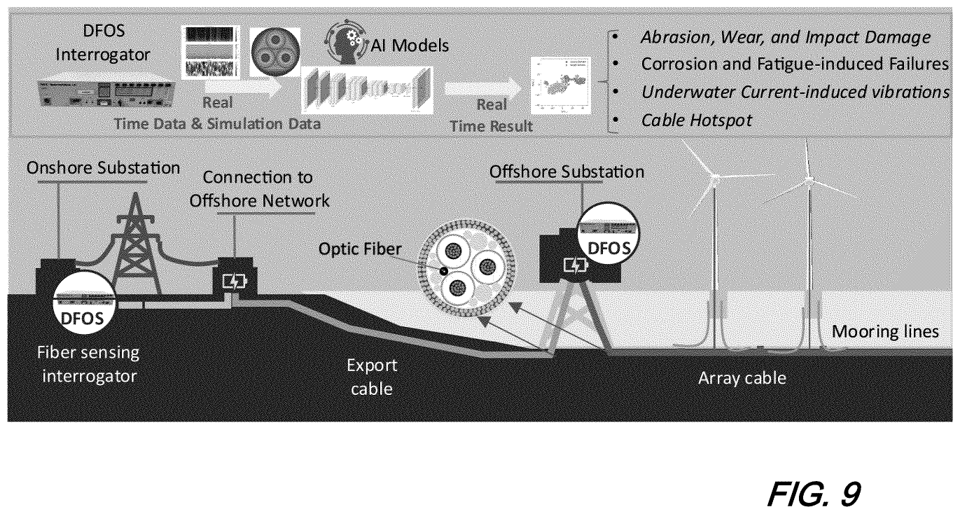

FIG. 9 is a schematic diagram showing an illustrative overview of a DFOS/DTS solution to an offshore wind turbine monitoring application according to aspects of the present disclosure.

As will be understood and appreciated by those skilled in the art, a key component of this illustrative arrangement shown in FIG. 9 is the DFOS interrogator, which acts as the data acquisition system capable of measuring up to 125 km of a single submarine cable. This interrogator connects to the optical fiber cables integrated within the submarine cable, whether it is an export cable or an array cable. The raw data collected by the DFOS interrogator is combined with simulation data from tools such as finite element analysis and fed into a machine learning model. This model is designed to predict various types of failures, including abrasion, wear and impact damage, corrosion, fatigue-induced failures, underwater current-induced vibration, and cable hotspots. Each type of failure exhibits distinct signatures and patterns, which advanced artificial intelligence models can analyze to identify, localize, and classify these faults or failures accurately.

As mentioned previously, key technology of DFOS includes DAS, DTS, and DSS. In this section, we first introduce the general principle of DOFS technology and then give an example of using DTS and finite element method for submarine cable hot spot detection. The scattering mechanisms in fiber that can be exploited for reflectometry based DFOS are Rayleigh, Brillouin, and Raman scatterings, as previously noted.

Rayleigh scattering is an elastic, linear scattering process where no energy is transferred between the incident light and the glass medium. The return light is at the same frequency as the input signal. If the input light is coherent, the backscatter from various points along the fiber interferes, resulting in a speckle pattern that is a signature of the fiber state, and can be characterized as a Rayleigh impulse response. If temperature changes or mechanical stress is applied, the interference pattern changes. By comparing the interference pattern over time, thermal and mechanical disturbances can be measured.

Alternatively, it can be viewed that longitudinal strain causes a change in optical distance between scatterers, translating into an optical phase change of the return light. Rayleigh scattering is the physical phenomenon used in DAS and DSS interrogators. In contrast to Rayleigh scattering, Brillouin and Raman scatterings are inelastic scattering processes where the incident light interacts with the propagation medium, and the return light is at a relative frequency shift compared with an input signal. Scatterings at frequencies below and above that of the incident light are called “Stokes” and “anti-Stokes” processes, respectively.

Finite Element Analysis (FEA) plays a crucial role in this integrated approach by simulating structural responses under different environmental and load conditions, making them invaluable tools for structural health monitoring in offshore wind turbines. This approach leverages FEM to simulate accurate temperature distributions within the cable, identify potential hot spots, and validate these findings with real-time DTS data.

By implementing advanced machine learning algorithms, the system continuously learns from both simulated and real-world data, predicting potential failure points and suggesting pre-emptive maintenance actions. The hybrid model, combining data-driven and physics-based approaches, incorporates uncertainty quantification methods to provide confidence intervals for predictions. This comprehensive solution enhances the reliability, efficiency, and lifespan of submarine cables, addressing the limitations of current methods and advancing the state of the art in thermal anomaly detection and predictive maintenance.

Validation results of the steady-state heat transfer analysis performed using Finite Element Analysis (FEA) compared against analytical results derived from Fourier's law of heat conduction confirm the utility of our inventive systems and methods along with their accuracy and reliability.

Once validated, the FEA model can be employed to simulate various “what-if” scenarios under different load and environmental conditions. These simulation results serve as valuable input data for training a physics-based machine learning model. This model, informed by the physics of the system, can predict potential failures and optimize maintenance strategies.

As those skilled in the art will understand and appreciate, our inventive FEA model may be further validated using real-time temperature data obtained from DTS interrogations. By integrating these data sources, a comprehensive machine learning model is developed that monitors the condition of offshore wind submarine cables effectively. This integrated model enhances the predictive maintenance capabilities, allowing for more accurate identification and localization of potential issues, thus improving the overall reliability and efficiency of offshore wind farm operations.

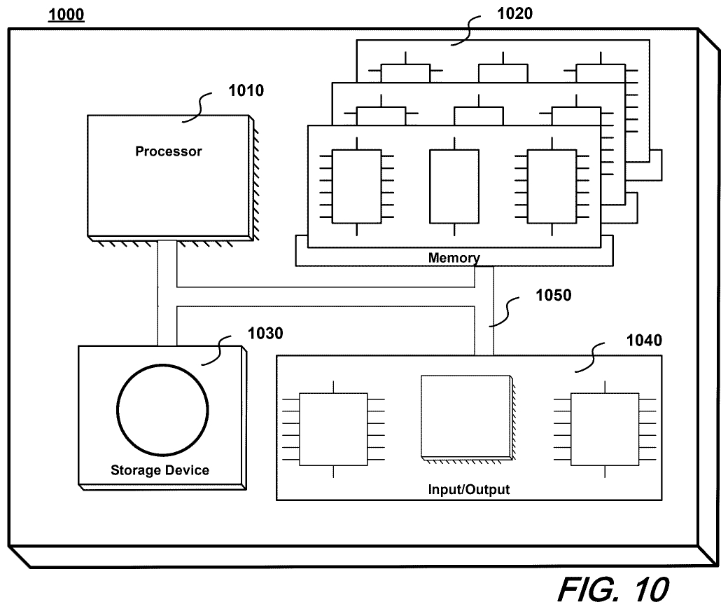

FIG. 10 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 1000 as stored program control instructions.

Computer system 1000 includes processor 1010, memory 1020, storage device 1030, and input/output structure 1040. One or more input/output devices may include a display 1045. One or more busses 1050 typically interconnect the components, 1010, 1020, 1030, and 1040. Processor 1010 may be a single or multi core. Additionally, the system may include accelerators etc., further comprising the system on a chip.

Processor 1010 executes instructions in which embodiments of the present disclosure may comprise steps described in one or more of the Drawing figures. Such instructions may be stored in memory 1020 or storage device 1030. Data and/or information may be received and output using one or more input/output devices.

Memory 1020 may store data and may be a computer-readable medium, such as volatile or non-volatile memory. Storage device 1030 may provide storage for system 1000 including for example, the previously described methods. In various aspects, storage device 1030 may be a flash memory device, a disk drive, an optical disk device, or a tape device employing magnetic, optical, or other recording technologies.

Input/output structures 1040 may provide input/output operations for system 1000.

At this point, those skilled in the art will understand and appreciate that we introduce a Deep Phase-Magnitude Network (DFMN) and point out that combining the filtering in time domain and frequency domain can significantly enhance the classification accuracy and improve the domain generalization ability. We divide the raw fiber sensing data into magnitude response and phase response for parallel feature representation learning. Furthermore, we propose a Phase Frequency Learnable Filter (PFLF) specifically designed for phase component learning, which effectively determines the frequency components crucial for enhancing rain detection accuracy. In the end, we formulate the phase-magnitude channel within a dual-path network and subsequently fuse the features for a comprehensive analysis. Extensive experiments and ablation studies demonstrate the effectiveness of our proposed method.

While we have presented our inventive concepts and description using specific examples, our invention is not so limited. Accordingly, the scope of our invention should be considered in view of the following claims.

1. A computer-implemented method for detecting thermal anomalies in a submarine cable including an optical fiber, the method comprising:
performing a finite element analysis (FEA) for the submarine cable to generate an FEA model of the submarine cable;
operating a distributed temperature sensing (DTS) system in optical communication with the optical fiber included in the submarine cable;
perform an integrative data analysis and model refinement that combines FEA and DTS data to refine simulations and enhance the FEA model accuracy;
apply machine learning models to predict thermal anomalies and potential failure points of the submarine cable;
predict maintenance and operational adjustments utilizing the machine learning predictions.

2. The method of claim 1 further comprising defining a geometry of the submarine cable from material layers comprising the submarine cable.

3. The method of claim 2 further comprising assigning material properties to each of the material layers comprising the submarine cable.

4. The method of claim 3 wherein the material properties include physical and thermal properties including one or more of density, elastic modulus, thermal conductivity, and specific heat capacity.

5. The method of claim 4 further comprising generating a finite element mesh for the submarine cable such that fine meshes are used in areas with high gradient predictions such as temperature or stress.

6. The method of claim 5 wherein the finite element mesh for the submarine cable is generated such that coarse mesh is used in less critical regions including an outer serving and armor layers.

7. The method of claim 6 further comprising conducting mesh sensitivity tests to systematically refine the mesh in particular areas of the finite element mesh and comparing outcomes of individual refinements.

8. The method of claim 7 further comprising validating the FEA model against experimental data and known analytical solutions.

9. The method of claim 7 further comprising collecting DTS temperature monitoring of the submarine cable to identify any deviations from predicted values and anomalies.

10. The method of claim 9 further comprising combining FEA and DTS data to refine any simulations and FEA model accuracy based on DTS temperature monitoring.
